(19) United States
(12) Patent Application Publication
(10) Pub. No.: US 2003/0063731 A1
(43) Pub. Date: Apr. 3, 2003

(54) Systems and methods for recording and providing enhanced caller information in an advanced intelligent network

(76) Inventor: Larry D. Woodring, Decatur, GA (US)

Correspondence Address: SHAW PITTMAN LLP, 1650 Tysons Boulevard, McLean, VA, 22102, US

(21) Appl. No.: 09/964,392

(22) Filed: Sep. 28, 2001

(51) Int. Cl. H04M 3/42; H04M 7/00

(52) U.S. Cl. 379/207.15; 379/207.02; 379/220.01

(57) ABSTRACT

An enhanced caller-id service providing calling name and calling number information to subscribers via a server system. The server system can combine the caller-id information with other data to provide more detailed reports for the subscriber. The server can also be used to maintain long-term calling records for subscribers. The caller-id information can be accessed remotely by the subscriber and can be downloaded from the server to another computer for use with other applications.

The present application is related to co-pending, commonly owned application of Larry D. Woodring, entitled “Systems and Methods for Providing User Profile Information in Conjunction With an Enhanced Caller Information System”, U.S. Pat. No. ______, now U.S. application Ser. No. ______, filed concurrently herewith, and which is herein incorporated by referenced in its entirety.

### BACKGROUND

1. Field of the Invention

The present invention relates generally to telecommunications systems, and more particularly, the present invention relates to enhanced advanced intelligent network (AIN) services and extension of those services to a multipurpose server system.

2. Background of the Invention

“Caller-id” services such as calling number delivery (CND) and calling name delivery (CNAM) are well-known services implemented in Advanced Intelligent Networks (“AIN”). The implementation and operation of CND systems are described in Bellcore Specification TR-NWT-000031, Calling Number Delivery, which is incorporated herein by reference in its entirety. CNAM systems are described in Bellcore Specification TR-NWT-001188, Calling Name Delivery Generic Requirements, which is incorporated herein by reference in its entirety.

Caller-id services operate by providing a signal to a caller-id display device attached to a subscriber's telephone line. The device interprets the signal and displays or stores the information for future display to the subscriber. Conventional caller-id services are not available when the subscriber is away from the home or office. That is, subscribers typically cannot access the information stored by the caller-id device without being physically present to operate the device. Another problem with conventional caller-id services is the necessity to have a caller-id device to record the calling number and name when a call is received. Caller-id devices typically have only a limited amount of memory so as to make them inadequate for long-term record-keeping purposes.

Some in the art have sought to overcome these problems by designing computer-based software and hardware systems which are connected to the subscriber's telephone line. When an incoming call is received, the signal destined for the caller-id device is intercepted and the information can be input into a database to make a log of all inbound calls. These systems have been known to fail and result in the subscriber's telephone being tied up until the subscriber is made aware of the problem. Also, such end-user solutions do not take full advantage of resources available with modem AIN systems.

### SUMMARY OF THE INVENTION

Embodiments of the present invention comprise systems and methods for providing enhanced caller-id information using an advanced intelligent network. The methods include provisioning a trigger on a subscriber's telephone line at a service switching point and receiving a call from a caller to the subscriber at the subscriber's service switching point (SSP). In response to the trigger, the SSP sends a query to a service control point (SCP). Upon receiving the query, the SCP sends an information message to a server for delivery to the subscriber upon request. The information message may include, for example, calling number, calling name, caller's address, caller's location (for mobile callers), calling date, calling time, call length, call ending time, and the like. The information on the server can be cross-referenced with other useful information such as a map of the caller's address or location.

Systems embodying the present invention may include a trigger provisioned on a subscriber's telephone line at the subscriber's SSP. When the SSP receives a call for the subscriber, the call hits the trigger, causing the SSP to send a query to an SCP. The query includes calling party number information and called party number information. The SCP responds to the query in the usual manner (e.g., by providing calling name information, if available), and additionally, the SCP sends an information message to a server. The server stores the information received from the SCP and, upon request, provides the subscriber with enhanced caller-id information. The server may also be used to maintain long-term logs recording the subscriber's caller activity. Additionally, the subscriber may download caller information for use with other applications.

Embodiments of the present invention may also be implemented for wireless subscribers and/or wireless callers. Further, embodiments may include servers adapted for access via the worldwide web or other commonly used applications accessible via communications networks, such as, for example, the Internet. In another embodiment the server may be adapted to provide information to the subscriber via a wireless device. In another embodiment a subscriber may access the server via a telephone call and receive calling information via voice message.

### BRIEF DESCRIPTION OF THE DRAWINGS

FIG. 1 is a schematic diagram showing the operation of an exemplary embodiment of the present invention.

FIG. 2 is a schematic diagram showing the operation of another exemplary embodiment of the present invention.

FIG. 3 is a schematic diagram showing the operation of another exemplary embodiment of the present invention.

FIG. 4 is a schematic diagram showing the operation of another exemplary embodiment of the present invention.

### DETAILED DESCRIPTION OF AN EMBODIMENT OF THE INVENTION

Embodiments of the present invention utilize AIN systems to provide a server-based caller-id service enabling subscribers to remotely receive calling number and calling name records for incoming calls. Providing such information via a server (e.g., a web-server, interactive voice response server and the like) allows subscribers to monitor their telephone records from any location from which access to the server is available. Further, embodiments of the present invention allow adjunct services for providing subscribers with enhanced caller-id information.

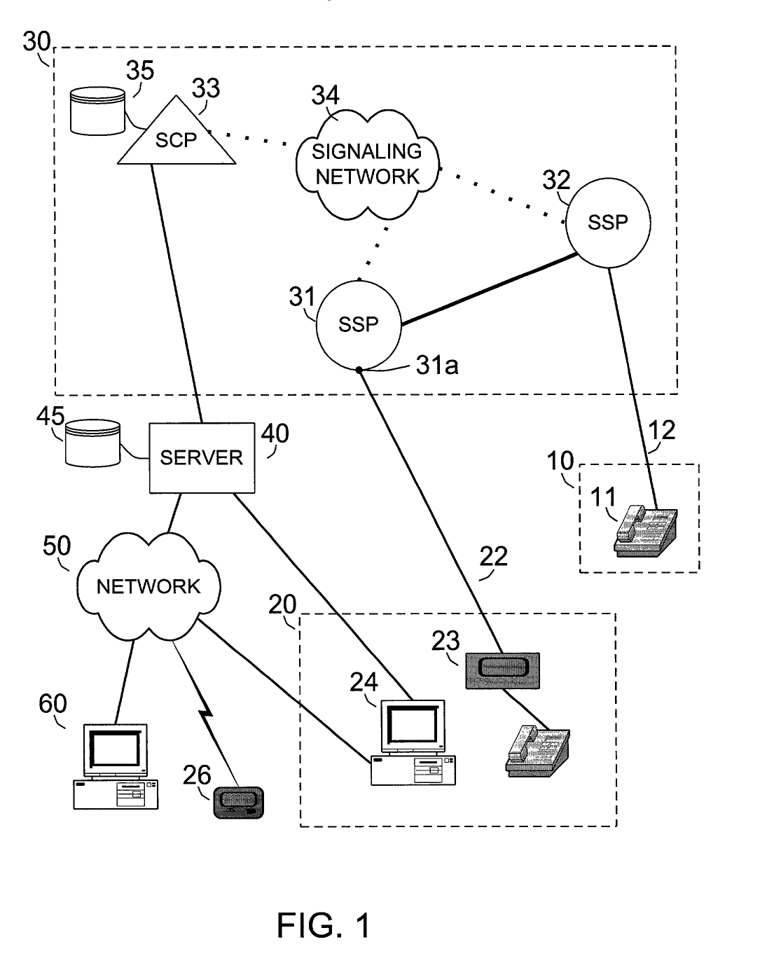

FIG. 1 is a schematic diagram showing an exemplary embodiment of the present invention. When caller 10 uses telephone 11 to place a call to subscriber 20, caller-id device 23 receives the calling name and/or calling number information as it would in conventional caller-id services. However, in addition to sending the information to caller-id device 23, AIN 30 also sends the information to server 40. Server 40 may be accessible from a computer used by subscriber 20, such as, for example, computer 24 located at subscriber 20's premises. As shown in FIG. 1, server 40 may be directly accessible by computer 24, or may be accessible via network 50. Network 50 may be any data communications network, such as, for example the well-known Internet. Additionally, subscriber 20 may use some other computer 60 or wireless device 26 to obtain the caller-id information via network 50, or direct access if server 40 is so configured.

FIG. 1 shows caller 10 having wireline 12 connected to service switching point (SSP) 32. However, as would be apparent to those skilled in the art, caller 10 could be calling from any telephony device, including, for example, a wireless telephone, a wireless interactive pager, an Internet calling device, and the like. When the call reaches subscriber 20's central office, SSP 31, it encounters trigger 31a provisioned on subscriber 20's wireline 22. As a result, SSP 31 issues a query to service control point (SCP) 33 via signaling network 34. As known in the art, the trigger may be a termination attempt trigger (TAT) or some other suitable trigger for initiating a query to SCP 33. Also as known in the art, signaling network 34 may be the well-known common channel signaling system number 7 (CC-SS7 or SS7) or some other signaling network. In response to the query, SCP 33 consults database 35 to locate the caller's calling name information.

SCP 33 provides the calling name information to SSP 31, which in turn provides the information to caller-id device 23. As known in the art, the calling name and number could be marked as private by the caller in which case the caller-id information provided to device 23 is “unavailable.” Further, as known in the art, the calling name may be indeterminate, in which case device 23 displays “unknown” for the calling name but may display the calling number. SCP 33 provides the information including, at least, the called party number and the calling number (if available) to server 40 to store in database 45 for access by subscriber 20. Server 40 may be any computer system adapted to provide access to database 45. For example, in one embodiment, server 40 may be a web server and computers 24 and 60 or wireless device 26 may include a web browser application for connecting to server 40. In another embodiment server 40 could be an FTP (file transfer protocol) server and computers 24 and 60 may include FTP client software to access data on server 40. In another embodiment server 40 may be, for example, a mail server from which subscriber 20 may download data via an email client on computers 24 or 60 or wireless device 26.

In one embodiment of the present invention, server 40 includes access control systems to maintain subscribers' privacy. In this embodiment, a subscriber can be prompted to provide a valid username and password or other security tokens before receiving any information about callers to his telephone line.

Server 40 may combine information received from SCP 33 with other information to enhance the caller-id service. For example, server 40 could provide additional geographical information such as the postal zip code of the caller or the caller's county, state, or country. Such information may be compiled and stored in database 45 and cross-referenced with the calling number and calling name information as needed. Similarly, server 40 may rearrange the information according to the subscriber's display preferences. For example, server 40 may provide a sort option to display information according to the date/time of the calls, by calling party number, by calling name, by geographic location, by area code, or other criteria.

Server 40 may also provide detailed reports to the subscriber and present information in many formats. For example, a report may be provided to summarize the prior month's calls. Another report may provide a breakdown of calls, for example, by time of day, by calling number, or other criteria.

In another embodiment of the present invention, SCP 33 may provide follow-up information regarding incoming calls. For example, after a call has ended, SCP 33 may send a message to server 40 indicating the length of the call. SCP 33 may also provide detailed information such as the circuit and trunk id for the call. In an exemplary configuration of this embodiment, SCP 33 may respond to SSP 31's query in the usual manner and also issues a Monitor-for-Change query, or other suitable instruction, to SSP 31. In response to the instruction SSP 31 monitors subscriber line 22 for a change in status (such as the line becoming idle after a call has ended). When SSP 31 detects the change in status it reports the event to SCP 33. SCP 33 may use this information, in conjunction with the original query to compute a call duration. The call duration may then be included in an information message sent from SCP 33 to server 40.

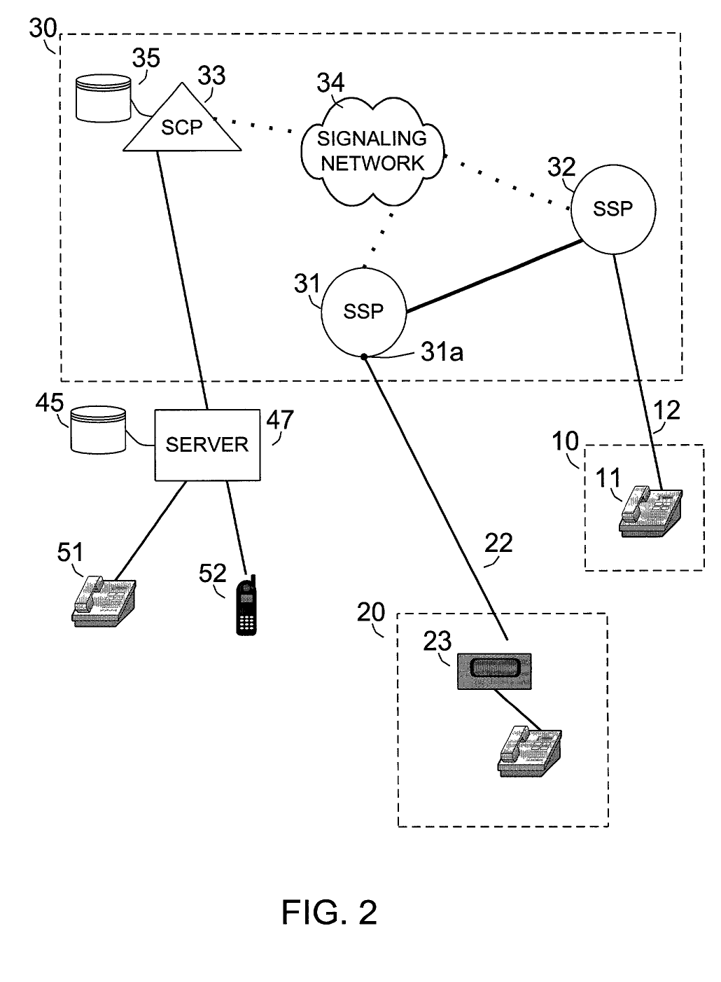

In an alternative embodiment, the server may include text-to-speech functionality allowing the subscriber to retrieve the caller-id information using any telephone device. FIG. 2 is a schematic diagram showing an exemplary configuration for this embodiment. Like numbered elements in FIG. 2 perform substantially the same functions are described above. Server 47 allows subscriber 20 to check the log for incoming calls placed to his or her telephone line 22. Using any telephone, such as, for example, telephone 51 or mobile telephone 52, subscriber 20 can call server 47 to hear a summary of inbound calls placed to wireline 22. This embodiment may incorporate an interactive voice response system providing a menu of options available to subscribers.

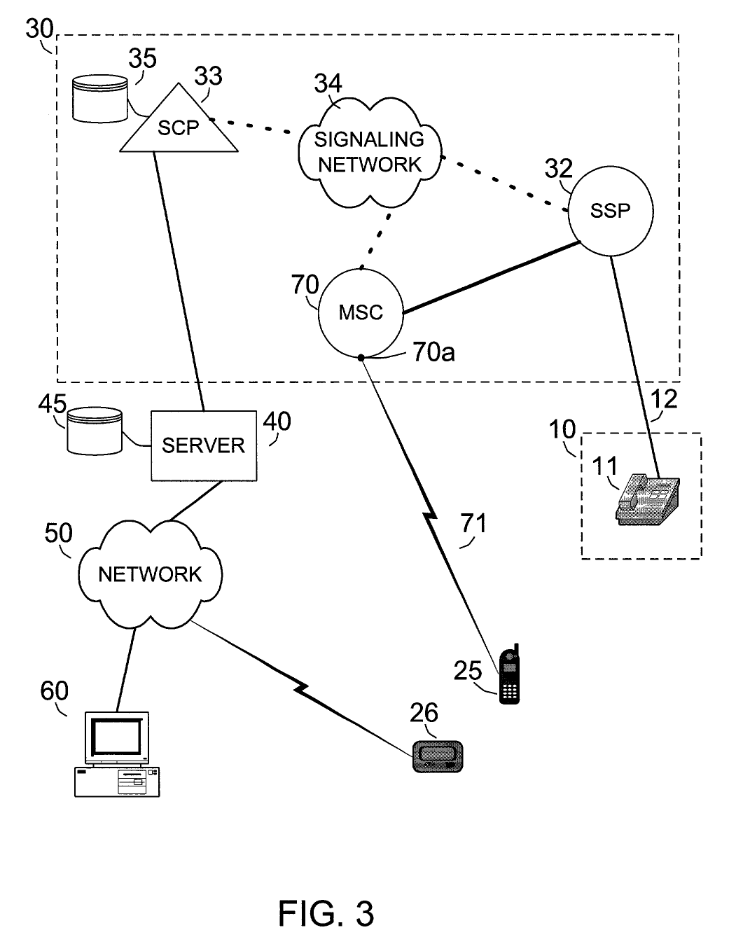

FIG. 3 is a schematic diagram showing another exemplary embodiment of the present invention. This embodiment includes many of the same elements as shown in FIGS. 1 and 2. However, instead of the subscriber having a separate caller-id device and a wireline, in this embodiment, the subscriber has a wireless telephone 25 with integrated caller-id services. As shown in FIG. 3, when caller 10 places a call to wireless telephone 25, it eventually reaches mobile switching center (MSC) 70 for delivery to wireless telephone 25 via wireless connection 71. Just as with wireline systems, trigger 70a on the subscriber's “line” may be provisioned at MSC 70. MSC 70 issues a query to SCP 33 via signaling network 34 in response to the trigger. Accordingly, when the incoming call reaches MSC 70, it sends a query to SCP 33. As described above, SCP 33 responds to the query as it normally would, but also sends caller-id information (for example, called party number, calling name and calling number) to server 40. The information sent by SCP 33 to server 40 in this embodiment may include any of the information already described above.

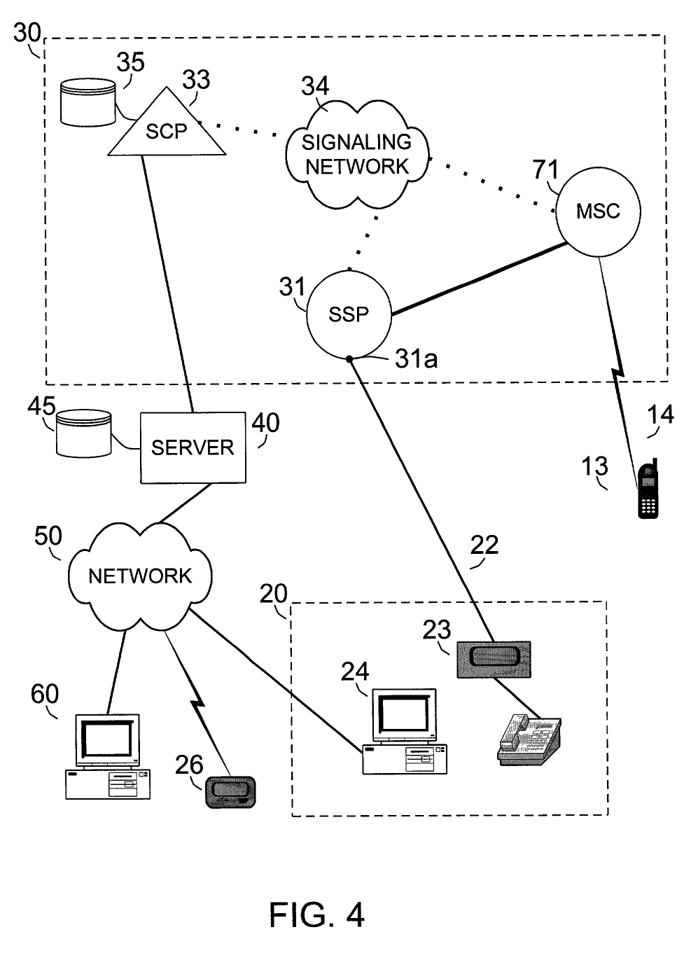

FIG. 4 is a schematic diagram showing another embodiment of the present invention. In this embodiment, the caller uses wireless telephone 13 and wireless connection 14 to call subscriber 20 via MSC 71. In this embodiment, MSC 71 is programmed to include the caller's geographic location information in a field of the initial address message (IAM) used to setup the call with SSP 31. This call encounters trigger 31a on subscriber 20's line 22 causing SSP 31 to issue a query to SCP 33. SSP 31 includes the location information in the query message for processing by SCP 33. Such information could be based on the cell-site from which the caller is calling or if emergency 911 services are implemented, a more precise location could be provided. SCP 33 includes the caller-id information (i.e., calling number, calling name, and the physical location of the caller) in the message sent to server 40.

In addition to providing near real-time views of incoming call information, the present invention provides a permanent or long-term log of all incoming call information in a database stored by the service provider. As described above, a subscriber may download this log onto a computer for historical or other uses. For example, a subscriber could use to the information to bill callers for the time spent on the telephone. Additionally, the caller-id data and historical log information could be integrated with other applications on the subscriber's computer, for example, address books, time-keeping logs, and the like. The information captured may be used in conjunction with existing web information services to create complete entries in address books such as those associated with email applications. Moreover, the information may be used to perform various business analyses such as geographic and demographic analysis of callers.

In another embodiment, the caller-id information could be integrated with unified communications interfaces that provide access to voice mail, email, faxes, etc. from a common web interface.

The foregoing disclosure of the preferred embodiments of the present invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure. The scope of the invention is to be defined only by the claims appended hereto, and by their equivalents.

Further, in describing representative embodiments of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

What is claimed is:

1. A method for recording and providing enhanced caller information using an advanced intelligent network, said method comprising:
provisioning a trigger on a subscriber's telephone line at a service switching point;
receiving a call from a caller to the subscriber at the service switching point, wherein said call encounters the trigger;
sending a query to a service control point in response to the trigger;
sending a message from the service control point to a server in response to the query, said message comprising a calling number and a called number; and
providing the calling number and other information to the subscriber from the server.

2. The method of claim 1, wherein the message further comprises a calling name.

3. The method of claim 1, wherein the other information further comprises a calling name.

4. The method of claim 1, wherein the other information further comprises a calling name, a calling date and a calling time.

5. The method of claim 1, wherein the other information further comprises a calling name, a calling date, a calling time, and a call length.

6. The method of claim 1, wherein the other information further comprises a calling name, a calling date, a calling time and a call stop time.

7. The method of claim 1, wherein the other information further comprises a caller address.

8. The method of claim 7, wherein the other information further comprises a map showing the caller's address.

9. The method of claim 1, wherein the other information further comprises a caller location.

10. The method of claim 9, wherein the other information further comprises a map showing the caller location.

11. The method of claim 1, wherein the server is a web-server accessible via the Internet.

12. The method of claim 1, wherein the server is a file transfer protocol-server accessible via the Internet.

13. The method of claim 1, wherein the server is an email-server accessible via the Internet.

14. The method of claim 1, wherein the server is an interactive voice response server accessible via a telephone call.

15. The method of claim 1, further comprising the step of receiving a username and a password on the server before the step of providing the calling number and other information.

16. The system of claim 1, wherein the server is accessible by the subscriber via a wireless device.

17. A system for providing enhanced caller information using an advanced intelligent network, said system comprising:
a trigger provisioned on a subscriber's telephone line at a service switching point;
a service control point in communication with the service switching point; and
a server in communication with the service control point,
wherein when a call to the subscriber is received at the service switching point, a query is sent from the service switching point to the service control point, and wherein in response to the query, the service control point sends a message to the server, and wherein in response to a request by the subscriber, the server provides a calling number to the subscriber.

18. The system of claim 17, wherein the server further provides a calling name to the subscriber.

19. The system of claim 17, wherein the server further provides a calling name, a calling date and a calling time to the subscriber.

20. The system of claim 17, wherein the server further provides a calling name, a calling date, a calling time, and a call length to the subscriber.

21. The system of claim 17, wherein the server further provides a calling name, a calling date, a calling time and a call stop time to the subscriber.

22. The system of claim 17, wherein the server further provides a caller address to the subscriber.

23. The system of claim 22, wherein the server further provides a map showing the caller's address to the subscriber.

24. The system of claim 17, wherein the server further provides a caller location to the subscriber.

25. The system of claim 24, wherein the server further provides a map showing the caller's address to the subscriber.

26. The system of claim 17, wherein the server is a web-server accessible via the Internet.

27. The system of claim 17, wherein the server is a file transfer protocol-server accessible via the Internet.

28. The system of claim 17, wherein the server is an email-server accessible via the Internet.

29. The system of claim 17, wherein the server is accessible by the subscriber via a wireless device.

30. A method for providing enhanced caller information using an advanced intelligent network, said method comprising:
provisioning a trigger on a subscriber's telephone line at a mobile switching center;
receiving a call from a caller to the subscriber at the mobile switching center, wherein said call encounters the trigger;
sending a query to a service control point in response to the trigger;
sending a message from the service control point to a server in response to the query, said message comprising a calling number and a called number; and
providing the calling number and other information to the subscriber from the server.

31. The method of claim 30, wherein message further comprises a calling name.

32. The method of claim 30, wherein the other information further comprises a calling name.

33. The method of claim 30, wherein the other information further comprises a calling name, a calling date and a calling time.

34. The method of claim 30, wherein the other information further comprises a calling name, a calling date, a calling time, and a call length.

35. The method of claim 30, wherein the other information further comprises a calling name, a calling date, a calling time and a call stop time.

36. The method of claim 30, wherein the other information further comprises a caller address.

37. The method of claim 36, wherein the other information further comprises a map showing the caller's address.

38. The method of claim 30, wherein the other information further comprises a caller location.

39. The method of claim 38, wherein the other information further comprises a map showing the caller's address.

40. The method of claim 30, wherein the server is a web-server accessible via the Internet.

41. The method of claim 30, wherein the server is a file transfer protocol-server accessible via the Internet.

42. The method of claim 30, wherein the server is an email-server accessible via the Internet.

43. The method of claim 30, further comprising the step of receiving a username and a password on the server before the step of providing the calling number and other information.

44. The system of claim 30, wherein the server is accessible by the subscriber via a wireless device.

45. A system for providing enhanced caller-id information using an advanced intelligent network, said system comprising:
a trigger provisioned on a subscriber's telephone line at a mobile switching center;
a service control point in communication with the mobile switching center; and
a server in communication with the service control point,
wherein when a call to the subscriber is received at the mobile switching center, a query is sent from the mobile switching center to the service control, and wherein in response to the query, the service control point sends a message to the server, and wherein in response to a request by the subscriber, the server provides a calling number to the subscriber.

46. The system of claim 45, wherein the server further provides a calling name to the subscriber.

47. The system of claim 45, wherein the server further provides a calling name, a calling date and a calling time to the subscriber.

48. The system of claim 45, wherein the server further provides a calling name, a calling date, a calling time, and a call length to the subscriber.

49. The system of claim 45, wherein the server further provides a calling name, a calling date, a calling time and a call stop time to the subscriber.

50. The system of claim 45, wherein the server further provides a caller address to the subscriber.

51. The system of claim 50, wherein the server further provides a map showing the caller's address to the subscriber.

52. The system of claim 45, wherein the server further provides a caller location to the subscriber.

53. The system of claim 52, wherein the server further provides a map showing the caller's address to the subscriber.

54. The system of claim 45, wherein the server is a web-server accessible via the Internet.

55. The system of claim 45, wherein the server is a file transfer protocol-server accessible via the Internet.

56. The system of claim 45, wherein the server is an email-server accessible via the Internet.

57. The system of claim 45, wherein the server is accessible by the subscriber via a wireless device.
